(19) United States
(12) Patent Application Publication
(10) Pub. No.: US 2017/0225554 A1
(43) Pub. Date: Aug. 10, 2017

(54) WEATHER STRIP

(71) Applicant: Nishikawa Rubber Co., Ltd., Hiroshima-shi (JP)

(72) Inventor: Kanji Matsuwaki, Hiroshima (JP)

(21) Appl. No.: 15/421,488

(22) Filed: Feb. 1, 2017

(30) Foreign Application Priority Data
Feb. 10, 2016 (JP) 2016-024088

(51) Int. Cl. B60J 10/80; B60J 10/33; B60J 10/21; B60J 10/15; B60J 10/25; B60J 10/277

(52) U.S. Cl. CPC B60J 10/80; B60J 10/25; B60J 10/277; B60J 10/21; B60J 10/15; B60J 10/33

(57) ABSTRACT

The present invention achieves a good closing of an opening and closing member, good sealing properties, good sound insulating properties, and good contour following properties.

A weather strip (10) includes a sealing section (12) having a main lip section (15) and a sub lip section (16). A space (S) surrounded by the main lip section (15), the sub lip section (16), a vehicle-interior-side upper wall section (12d), and an opening and closing member (back door 4) is contained within a region (R) between the sealing section (12) and the opening and closing member (back door 4) facing each other.

This Nonprovisional application claims priority under 35 U.S.C. §119 on Patent Application No. 2016-024088 filed in Japan on Feb. 10, 2016, the entire contents of which are hereby incorporated by reference.

### TECHNICAL FIELD

The present invention relates to a weather strip which is attached to a peripheral section of an opening of an automobile.

### BACKGROUND ART

Conventionally, there have been developed weather strips having different structures in order to improve sealing properties and sound insulating properties.

For example, Patent Literature 1 discloses a weather strip including a hollow seal lip whose lip wall on an outer side of a vehicle is bent so as to be a projection (hereinafter, “first projection”) near the top of the lip wall and whose lip wall on an inner side of the vehicle is bent so as to be a projection (hereinafter, “second projection”) near the top of the lip wall. Further, for example, Patent Literature 2 discloses a weather strip including (i) a main tongue which has a cavity inside thereof and has a projection on the top thereof and (ii) an auxiliary tongue piece which is provided at an inner circumferential section of the main tongue so as to extend along the main tongue. Further, for example, Patent Literature 3 discloses an opening weather strip including (i) a hollow seal lip section which has a projection on the top thereof and (ii) a secondary seal lip which is provided on a wall surface, on an interior-side, of the hollow seal lip section so as to extend along a longitudinal direction of the hollow seal lip section.

### CITATION LIST

### Patent Literature

[Patent Literature 1]

Japanese Patent Application Publication, Tokukaisho, No. 61-215144 A (Publication Date: Sep. 24, 1986)

[Patent Literature 2]

Japanese Utility Model Application Publication, Jitsukaisho, No. 49-107011 U (Publication Date: Sep. 12, 1974)

[Patent Literature 3]

Japanese Patent Application Publication, Tokukaihei, No. 9-132035 A (Publication Date: May 20, 1997)

### SUMMARY OF INVENTION

### Technical Problem

However, the weather strip disclosed in Patent Literature 1 has a problem that sealing properties and sound insulating properties cannot be improved enough in a standard bending state of the hollow seal lip, since the second projection does not abut against a lid in a case where the lid abuts against the first projection so as to allow the hollow seal lip to maintain the standard bending state. There is also a problem that, in a case where the lid is excessively compressed so that both of the first projection and the second projection abut against the lid, reactive force to the lid is increased, so that the lid does not close properly. The weather strip disclosed in Patent Literature 2 also has an arrangement in which the auxiliary tongue piece does not abut against a trunk lid panel in a state where the trunk lid panel is closed. Further, in a case where the thickness of the auxiliary tongue piece is increased so that the auxiliary tongue piece protrudes to a height approximately equal to the main tongue, reactive force applied to the trunk lid panel increases. The weather strip disclosed in Patent 2 thus has similar problems as those of the weather strip disclosed in Patent Literature 1.

The opening weather strip disclosed in Patent Literature 3 has a structure in which a bent section of the secondary seal lip significantly protrudes toward an inner side of the vehicle. As such, in a case where the opening weather strip is attached to a door opening, the secondary seal lip deforms into an undesirable shape by failing to completely follow a contour of the door opening at a corner of the door opening. This prevents the opening weather strip from sufficiently abutting against glass and accordingly resulted in a problem that sealing properties and sound insulating properties at the corner of the door opening are deteriorated.

The present invention is accomplished in view of the foregoing problems. An object of the present invention is to provide a weather strip which both enables improvement of sealing properties and sound insulating properties at portions including a corner of a peripheral section of an opening, and ensures a good closing of a door, a trunk, and the like.

### Solution to Problem

In order to attain the object, a weather strip in accordance with an aspect of the present invention is a weather strip attached to a peripheral section of an opening of an automobile, including: an attachment base secured along the peripheral section; a sealing section for sealing between the peripheral section and an opening and closing member for closing the opening, the sealing section being continuous with the attachment base and having (i) a vehicle-interior-side bent section which is bent so as to protrude toward an inner side of the automobile and (ii) a vehicle-exterior-side bent section which is bent so as to protrude toward an outer side of the automobile; a main lip section provided at a top of the sealing section and elastically coming into contact with the opening and closing member; and a sub lip section provided on a vehicle-interior-side upper wall section of the sealing section, the vehicle-interior-side upper wall section being provided between the top and the vehicle-interior-side bent section, the sub lip section elastically coming into contact with the opening and closing member, in a state where the weather strip seals between the peripheral section and the opening and closing member, a space surrounded by the main lip section, the sub lip section, the vehicle-interior-side upper wall section, and the opening and closing member being contained in a region between the sealing section and the opening and closing member facing each other.

### Advantageous Effects of Invention

A weather strip in accordance with an aspect of the present invention both enables improvement of sealing properties and sound insulating properties at portions including a corner of a peripheral section of an opening, and ensures a good closing of an opening and closing member.

### BRIEF DESCRIPTION OF DRAWINGS

(a) of FIG. 1 is a perspective view schematically illustrating an arrangement around a door opening of an automobile to which a weather strip in accordance with an embodiment of the present invention is attached. (b) of FIG. 1 is a cross-sectional view schematically illustrating an arrangement around a portion where the weather strip is attached, in a state where a back door of the automobile is closed.

FIG. 2 is a cross-sectional view schematically illustrating an arrangement of a weather strip in accordance with an embodiment of the present invention.

(a) through (c) of FIG. 3 are cross-sectional views each illustrating a state where a weather strip in accordance with an embodiment of the present invention and a sealing surface of a back door are in contact with each other.

(a) of FIG. 4 is a view illustrating a test method for checking sound insulating properties of a weather strip in accordance with an embodiment of the present invention. (b) of FIG. 4 is a graph showing a result obtained by carrying out the test method.

FIG. 5 is a graph showing a relation between (i) a distance from a design reference plane to a sealing surface of a back door and (ii) a compressive load exerted to the back door.

(a) and (b) of FIG. 6 are cross-sectional views schematically illustrating respective arrangements of weather strips in accordance with other embodiments of the weather strip in accordance with the present invention.

(a) through (f) of FIG. 7 are cross-sectional views schematically illustrating respective arrangements of weather strips in accordance with other embodiments of the weather strip in accordance with the present invention.

### DESCRIPTION OF EMBODIMENTS

<Example of Attachment of Weather Strip>

The following description will first discuss, with reference to FIG. 1, a structure around an opening of an automobile to which a weather strip in accordance with the present invention is attached. (a) of FIG. 1 is a perspective view schematically illustrating an arrangement around a door opening 3 of an automobile 1 to which a weather strip in accordance with an embodiment of the present invention is attached. (b) of FIG. 1 is a cross-sectional view schematically illustrating an arrangement around a portion where the weather strip 10 is attached, in a state where a back door 4 of the automobile 1 is closed.

As illustrated in (a) of FIG. 1, the automobile 1 of a hatchback type includes the back door (opening and closing member) 4 in a rear section thereof, and the door opening (opening) 3 in a portion of a body panel 2 in which portion the back door 4 is provided. The back door 4 is an openable and closable automobile component for closing the door opening 3.

The weather strip 10 in accordance with the embodiment of the present invention is attached to a peripheral section 3a of the door opening 3 throughout an entire circumference of the peripheral section 3a. The weather strip 10 is an automobile component for sealing between the peripheral section 3a of the door opening 3 and the back door 4. Specifically, as illustrated in (b) of FIG. 1, an attachment base 11 (described later) is attached to a flange 2a which (i) stands upright from an end of the body panel 2 so as to be substantially perpendicular to a sealing surface 4a of the back door 4 in a state where the back door 4 is closed and (ii) extends along the peripheral section 3a of the door opening 3. When the back door 4 is closed, a main lip section 15 and a sub lip section 16 of the weather strip 10 comes in contact with the sealing surface 4a of the back door 4. In this manner, the two lip sections come in contact with the back door 4, so that sealing between the peripheral section 3a of the door opening 3 and the back door 4 is achieved.

The weather strip 10 is made of a sponge-like rubber. A material for the rubber can be, for example, EPDM (ethylene-propylene-diene copolymer). Note that other rubber materials or other elastic materials having a rubber-like elasticity, such as IR (isoprene rubber), CR (chloroprene rubber), a thermoplastic elastomer (olefin or styrene thermoplastic elastomer), soft polyvinyl chloride, and the like can be used as a molding material. Further, a part or whole of the weather strip 10 can be made of a solid material.

Note that the above-described attachment of the weather strip 10 is merely an example. For example, the weather strip 10 can be attached to peripheral sections (not shown) of door openings respectively corresponding to a front door 5 and a rear door 6 of the automobile 1. It is also possible to attach the weather strip 10, for example, to a peripheral section (not shown) of an opening corresponding to a trunk lid (opening and closing member) of a sedan-type automobile. In other words, there is no particular limitation on (i) a type of an opening and closing member such as a door, (ii) a structure of a peripheral section of an opening, and (iii) the like, to which a weather strip in accordance with the present invention, such as the weather strip 10, is applied.

<Structure of Weather Strip>

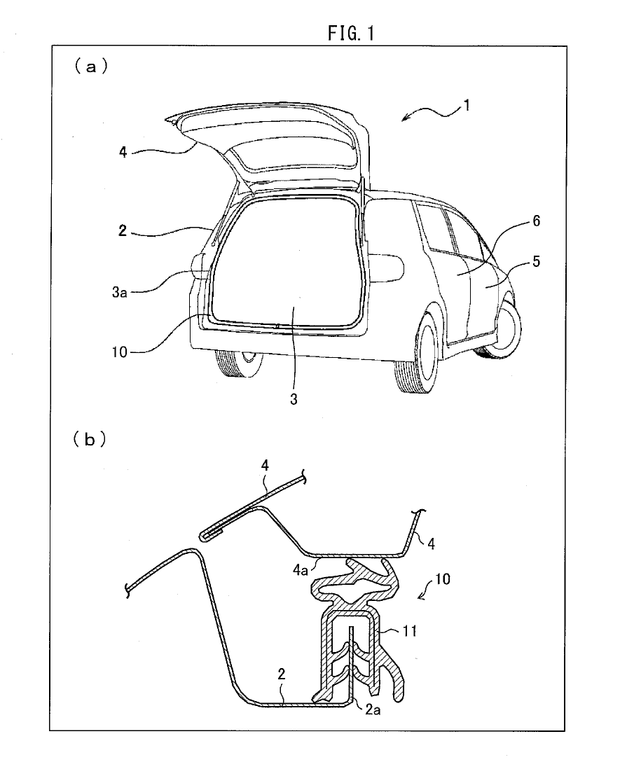

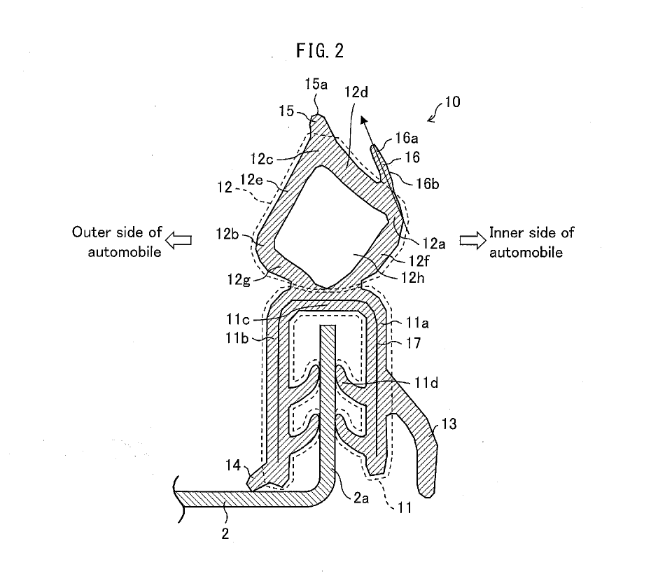

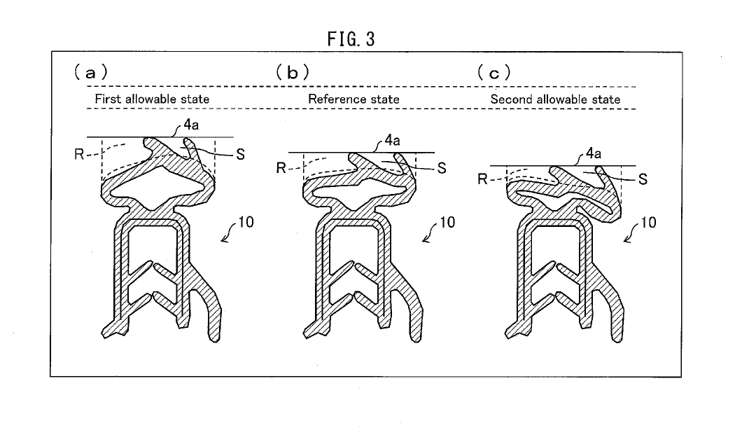

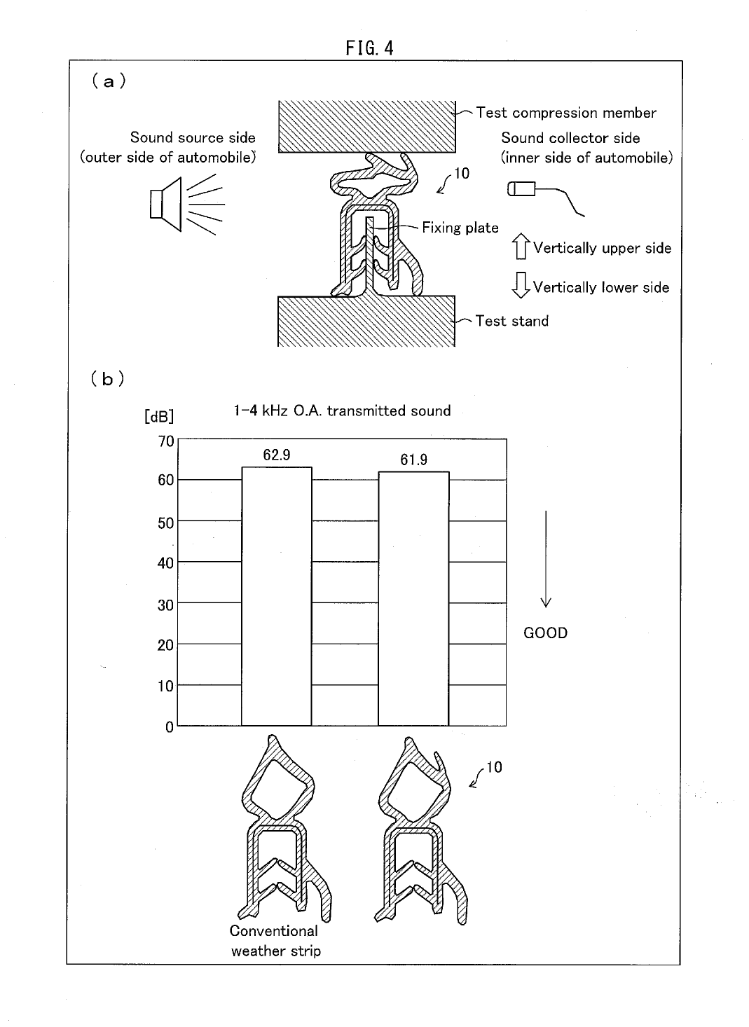

The following description will next discuss, with reference to FIG. 2, a structure of the weather strip in accordance with the present invention. FIG. 2 is a cross-sectional view schematically illustrating an arrangement of the weather strip 10. FIG. 2 shows cross sections of the body panel 2, the flange 2a, and the weather strip 10, wherein a right-hand side and a left-hand side of a drawing sheet of FIG. 2 respectively correspond to an inner side of the automobile (a vehicle interior side) and an outer side of the automobile (a vehicle exterior side). As illustrated in FIG. 2, the weather strip 10 includes the attachment base 11, a sealing section 12, a vehicle-interior lip section 13, and a vehicle-exterior lip section 14.

The attachment base 11 is a portion having a substantially U-shaped cross section and including a vehicle-interior wall section 11a, a vehicle-exterior wall section 11b, and a connection wall section 11c which connects between the vehicle-interior wall section 11a and the vehicle-exterior wall section 11b. On an inner surface of each of the vehicle-interior wall section 11a and the vehicle-exterior wall section 11b, two holding lip sections 11d for holding the flange 2a are provided. Further, inside the attachment base 11, a core 17 having a substantially U-shaped cross section is embedded in order to secure the attachment base 11 to the flange 2a more firmly.

Note that the number of holding lip sections 11d are appropriately changeable. Further, the attachment base 11 does not have to be provided with any holding lip section 11d. In this case, for example, a vehicle-interior wall section 11a and a vehicle-exterior wall section 11b, each molded to have a greater thickness, sandwich the flange 2a directly therebetween so as to secure the attachment base 11 to the flange 2a (not shown). Further, the attachment base 11 does not have to have any core 17 embedded therein.

The sealing section 12 is a pantograph-shaped portion with a substantially rhombus cross section, for sealing between the peripheral section 3a of the door opening 3 and the back door 4. The sealing section 12 is molded (formed so as to be continuous with the attachment base) integrally with the connection wall section 11c of the attachment base 11, and contains a hollow section 12h inside. The provision of the hollow section 12h allows the sealing section 12 to be compressed more easily when the back door 4 is closed. This allows reducing reactive force applied to the back door 4.

The sealing section 12 also has a vehicle-interior-side bent section 12a which is bent so as to protrude toward the inner side of the automobile, and a vehicle-exterior-side bent section 12b which is bent so as to protrude toward the outer side of the automobile. Both of the vehicle-interior-side bent section 12a and the vehicle-exterior-side bent section 12b bend as a result of compression of the sealing section 12 when the back door 4 is closed (see (b) of FIG. 1).

Further, the sealing section 12 has an vehicle-interior-side upper wall section 12d which is provided between a top (a top of the sealing section) 12c and the vehicle-interior-side bent section 12a, and an exterior-side upper wall section 12e which is provided between the top 12c and the vehicle-exterior-side bent section 12b. The sealing section 12 also has a vehicle-interior-side lower wall section 12f which is provided between the connection wall section 11c of the attachment base 11 and the vehicle-interior-side bent section 12a, and a vehicle-exterior-side lower wall section 12g which is provided between the connection wall section 11c and the vehicle-exterior-side bent section 12b.

Note that the sealing section 12 does not necessarily have to be pantograph-shaped with a substantially rhombus cross section, and does not have to contain the hollow section 12h inside. In other words, it is only necessary that the sealing section 12 have a structure including at least the vehicle-interior-side bent section 12a and the vehicle-exterior-side bent section 12b.

The vehicle-interior lip section 13 has a shape of fin and extends from an outer surface of the vehicle-interior wall section 11a of the attachment base 11 so that a tip of the vehicle-interior lip section 13 faces a body panel 2 side. The vehicle-interior lip section 13 covers an end (not shown) of an interior material or is embedded into the end, thereby improving design. The vehicle-exterior lip section 14 is a portion having a projecting cross section and projects from an outer surface of an end of the vehicle-exterior wall section 11b of the attachment base 11. A tip of the vehicle-exterior lip section 14 is in contact with the body panel 2, thereby enhancing sealing properties.

The main lip section 15 is a portion having a projecting cross section and projects from an outer surface of the top 12c of the sealing section 12. In a state where the back door 4 is closed, the main lip section 15 is elastically in contact with the sealing surface 4a of the back door 4, thereby enhancing sealing properties (see (b) of FIG. 1).

The sub lip section 16 has a shape of fin and extends from an outer surface of the vehicle-interior-side upper wall section 12d of the sealing section 12. A tip 16a of the sub lip section 16 is closer to the attachment base 11 than a tip 15a of the main lip section 15 is, and an outer surface (vehicle-interior-side side surface) 16b of the sub lip section 16 is closer to the outer side of the automobile than the vehicle-interior-side bent section 12a is. Further, the sub lip section 16 extends from the vehicle-interior-side upper wall section 12d of the sealing section 12 in a direction indicated by a solid line arrow of FIG. 2, that is, from the inner side to the outer side of the automobile. In a state where the back door 4 is closed, the sub lip section 16 is elastically in contact with the back door 4, thereby enhancing sealing properties together with the main lip section 15 ((b) of FIG. 1).

<Contact Between Weather Strip and Back Door>

Next, the following description will discuss, with reference FIG. 3, contact between the weather strip in accordance with the present invention and the opening and closing member. (a) through (c) of FIG. 3 are cross-sectional views each illustrating a state where the weather strip 10 and the sealing surface 4a of the back door 4 are in contact with each other.

The weather strip 10 seals between the peripheral section 3a of the door opening 3 and the back door 4 within a range of load allowable from a design viewpoint with respect to reactive force exerted from the sealing section 12 to the back door 4. Note here that the reactive force exerted to the back door 4 is generated by bending of the vehicle-interior-side bent section 12a and the vehicle-exterior-side bent section 12b of the sealing section 12 when the back door 4 is closed.

First, as illustrated in (a) of FIG. 3, not only the main lip section 15 but also the sub lip section 16 is in contact with the sealing surface 4a in a first allowable state in which the back door 4 is closed so that a reactive force exerted to back door 4 is at a minimum value of the range of allowable load. Thus, the weather strip 10 is able to exhibit a good sealing function due to the contact of the two lip sections 15 and 16, while maintaining a good closing of the back door 4.

Both in a reference state in which the back door 4 is closed so that a reactive force exerted to the back door 4 is at a reference value of the range of load allowable from a design viewpoint ((b) of FIG. 3) and in a second allowable state in which the back door 4 is closed so that the reactive force is at a maximum value of the range of allowable load ((c) of FIG. 3), there are substantially no changes in shape and positional relation of the sub lip section 16. That is, both in the reference state and the second allowable state, the outer surface 16b of the sub lip section 16 remains located closer to the outer side of the automobile than the vehicle-interior-side bent section 12a is, and the direction in which the sub lip section 15 extends from the vehicle-interior-side upper wall section 12d of the sealing section 12 remains a direction from the inner side to the outer side of the automobile. As a matter of course, there are substantially no changes in shape and positional relation of the sub lip section 16 in the first allowable state.

As described above, there are substantially no changes in shape and positional relation of the sub lip section 16 in a case where the weather strip 10 comes in contact with the back door 4 within a range of load allowable from a design view point with respect to a reactive force exerted to the back door 4. Accordingly, a state of contact between the sub lip section 16 and the sealing surface 4a of the back door 4 is stabilized, so that the weather strip 10 can exhibit a stable sealing function.

Note that it is not essential that the outer surface 16b of the sub lip section 16 be located closer to the outer side of the automobile than the vehicle-interior-side bent section 12a is in a case where the weather strip 10 is in contact with the back door 4 within the range of allowable load. Also, it is not essential that the direction in which the sub lip section 16 extends from the vehicle-interior-side upper wall section 12d of the sealing section 12 be from the inner side to the outer side of the automobile. That is, changes in shape and positional relation of the sub lip section 16 may be accepted as long as the weather strip 10 can exhibit a stable sealing function.

Specifically, a shape and a positional relation of the sub lip section 16 are appropriately changeable provided that, as illustrated in FIG. 3, a space S surrounded by the main lip section 15, the sub lip section 16, the vehicle-interior-side upper wall section 12d, and the sealing surface 4a of the back door 4 is contained within a region R between the sealing section 12 and the back door 4 facing each other, in a state where the weather strip 10 seals between the peripheral section 3a of the door opening 3 and the back door 4 within the range of allowable load. Note that the ‘sealing section 12’ which faces the back door 4 refers to ‘an upper wall of the sealing section’ which upper wall is continuously constituted by the vehicle-interior-side bent section 12a, the vehicle-interior-side upper wall section 12d, the top 12c, the exterior-side upper wall section 12e, and the vehicle-exterior-side bent section 12b.

<Performance of Weather Strip>

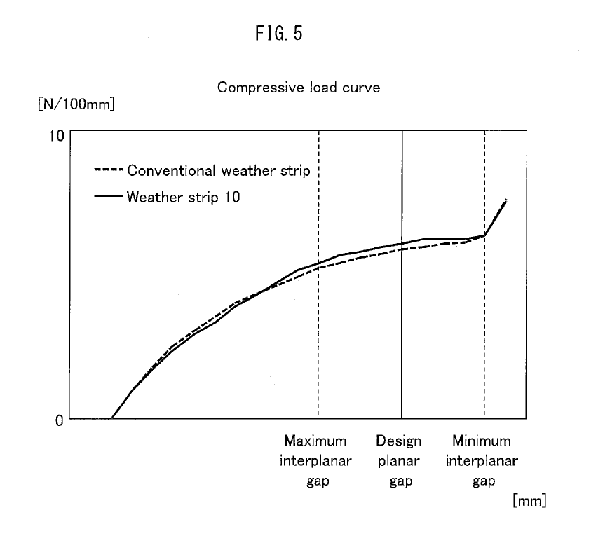

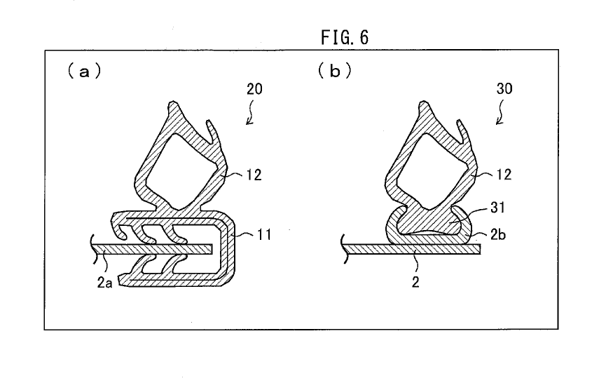

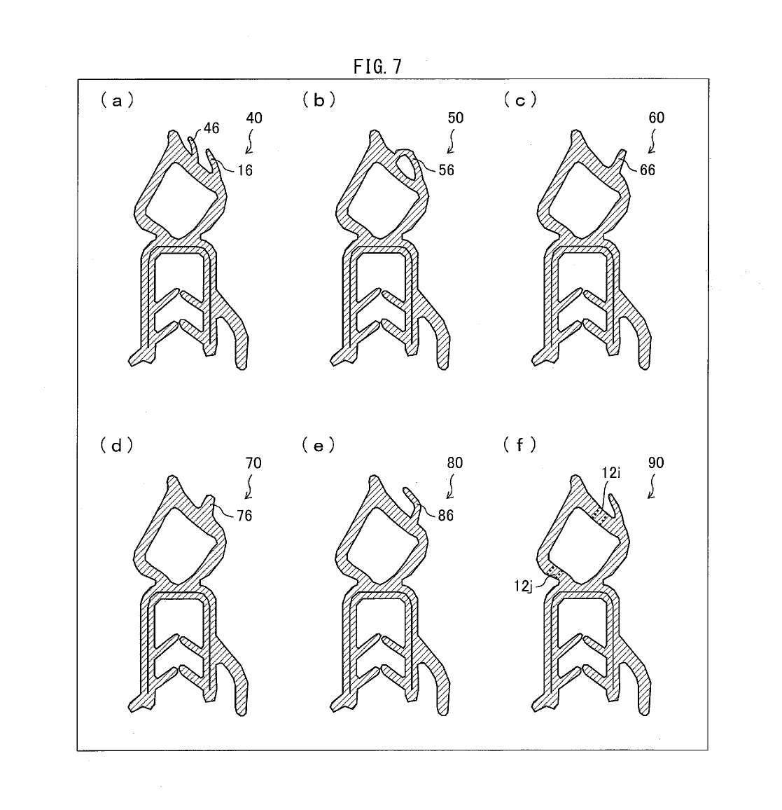

Next, the following description will discuss a performance of the weather strip 10 with reference to FIGS. 4 and 5. (a) of FIG. 4 is a view illustrating a test method for checking sound insulating properties of the weather strip 10. (b) of FIG. 4 is a graph showing a result obtained by carrying out the test method. FIG. 5 is a graph showing a relation between (i) a distance from a design reference plane to the sealing surface 4a of the back door 4 and (ii) a compressive load (reactive force) exerted to the back door 4.

First, sound insulating properties of the weather strip 10 will be discussed. In order to check sound insulating properties of the weather strip 10, a test illustrated in (a) of FIG. 4 was carried out. First, the weather strip 10 was attached to a fixing plate having a substantially same shape as the flange 2a and standing upright on the test stand, and a lower surface of a test compression member was brought into contact with the main lip section 15 and the sub lip section 16. Then, the test compression member was lowered until the reference state ((b) of FIG. 3) was reached. In this state, a predetermined sound (1 kHz to 4 kHz O.A. (overall value: a total value of sound pressure levels at respective frequencies obtained as a result of performing a frequency analysis by use of fast Fourier sine cosine transformation)) was outputted from a sound source, and sound having been transmitted through the weather strip 10 was collected by use of a sound collector. The same test was carried out also with respect to a conventional weather strip (see (b) of FIG. 4) which had no sub lip section 16. Note here that the sound source was disposed in a position which would correspond to the outer side of the automobile in a case where the weather strip 10 is attached to the peripheral section 3a of the door opening 3. The sound collector was disposed in a position which would correspond to the inner side of the automobile of the same case.

As shown in FIG. 4, in a case of attaching the conventional weather strip, transmitted sound which was collected by the sound collector was 62.9 dB, whereas in a case of attaching the weather strip 10, transmitted sound which was collected by the sound collector was 61.9 dB. The weather strip 10 thus had a decrease in transmitted sound by 1.0 dB compared to the conventional weather strip. From this test result, it was revealed that the weather strip 10 exhibits good sound insulating properties because of having more sound insulating portions due to the provision of the sub lip section 16.

Next, sealing properties of the weather strip 10 will be discussed. A CAE (Computer Aided Engineering) analysis was carried out with respect to each of the conventional weather strip (see (b) of FIG. 4) and the weather strip 10. As a result, as shown in FIG. 5, the weather strip 10 had a greater compressive load than the conventional weather strip by approximately 0.2 N/100 mm, both in a maximum interplanar gap which represents a distance from a design reference plane to the sealing surface 4a of the back door 4 in the first allowable state (see (a) of FIG. 3) and in a design planar gap which represents this distance in the reference state (see (b) of FIG. 3).

This result indicates that a compressive load increases as contact between the sub lip section 16 and the sealing surface 4a increases. That is, the result indicates that the weather strip 10 has more sealing portions compared to the conventional weather strip. It was thus revealed from the result that the weather strip 10 has good sealing properties.

<Variations of Weather Strip>

An embodiment of the weather strip in accordance with the present invention is not limited to the weather strip 10 described above, and more variations of embodiments can be assumed. The following description will discuss this point with reference to (a) and (b) of FIG. 6 and (a) through (f) of FIG. 7. (a) and (b) of FIG. 6 are cross-sectional views schematically illustrating respective arrangements of weather strips 20 and 30 in accordance with other embodiments of the weather strip in accordance with the present invention. (a) through (f) of FIG. 7 are cross-sectional views schematically illustrating respective arrangements of weather strips 40, 50, 60, 70, 80, and 90 in accordance with other embodiments of the weather strip in accordance with the present invention.

First, the weather strip in accordance with the present invention encompasses, as an embodiment, the weather strip 20 having a structure in which the sealing section 12 is integrally molded with the vehicle-interior wall section 11a or the vehicle-exterior wall section 11b of the attachment base 11 as illustrated in (a) of FIG. 6, in order to cope with a case in which the flange 2a extends from the body panel 2 in a horizontal direction.

The weather strip in accordance with the present invention also encompasses, as an embodiment, a weather strip 30 having a structure in which the sealing section 12 is integrally molded with an attachment base 31 as illustrated in (b) of FIG. 6, in order to cope with a case in which, in place of the flange 2a, an engaging section 2b having a substantially C-shaped cross section is provided on a surface (see (b) of FIG. 1) of the body panel 2 on a back door 4 side. The attachment base 31 has a shape corresponding to a shape of a region of the engaging section 2b where engagement occurs. Causing the attachment base 31 to be engaged with the engaging section 2b allows the weather strip 30 to be attached.

As described above, an attachment base of the weather strip in accordance with the present invention can have any shape in accordance with a structure of a peripheral section of the opening, as long as the shape allows the attachment base to be secured along the peripheral section.

Further, the weather strip in accordance with the present invention encompasses, as an embodiment, the weather strip 40 having a structure in which, in addition to the sub lip section 16, a second sub lip section (sub lip section) 46 is provided so as to extend from the outer surface of the vehicle-interior-side upper wall section 12d of the sealing section 12, as illustrated in (a) of FIG. 7. The second sub lip section 46 is provided closer to the outer side of the automobile than the sub lip section 16 is, and a tip of the second sub lip section 46 is provided closer to the attachment base 11 than the tip 15a of the main lip section 15 is. Further, so as not to prevent the sub lip section 16 from coming into contact with the back door 4, the second sub lip section 46 extends from the sealing section 12 in a direction substantially identical to the direction in which the sub lip section 16 extends. The provision of the two sub lip sections 16 and 46 allows further improving sound insulating properties and sealing properties.

Note that the tip of the second sub lip section 46 does not necessarily have to be located closer to the attachment base 11 than the tip 15a of the main lip section 15 is, but in order to prevent deteriorating a closing of the back door 4, the tip of the second sub lip section 46 is preferably located closer to the attachment base 11 than the tip 15a is. Further, it is also possible to provide three or more sub lip sections to the weather strip in accordance with the present invention.

The weather strip in accordance with the present invention also encompasses, as an embodiment, the weather strip 50 having a structure in which a bulging section (sub lip section) 56 is provided in place of the sub lip section 16, as illustrated in (b) of FIG. 7. The bulging section 56 has a shape that would be obtained by causing the sub lip section 16 to curve so as to protrude toward the inner side of the automobile and, in this state, connecting the tip 16a of the sub lip section 16 to the vehicle-interior-side upper wall section 12d. The bulging section 56 has a smoothly bulging outer shape.

Further, the weather strip in accordance with the present invention encompasses, as an embodiment, the weather strip 60 having a structure in which a sub lip section 66 is provided in place of the sub lip section 16, as illustrated in (c) of FIG. 7. The sub lip section 66 is arranged similarly to the sub lip section 16 in terms of a positional relation between a tip of the sub lip section 66 and the tip 15a of the main lip section 15 and a position of an outer surface of the sub lip section 66. The sub lip section 66, however, is arranged such that a direction in which the sub lip section 66 extends from the sealing section 12 is from the outer side to the inner side of the automobile. The tip of the sub lip section 66 may be located closer to the inner side of the automobile than the vehicle-interior-side bent section 12a is. However, in view of, for example, allowing the sub lip section 66 to follow a contour of the peripheral section 3a (see (a) of FIG. 1) of the door opening 3 at a corner of the peripheral section 3a, it is preferable that the tip of the sub lip section 66 be provided closer to the outer side of the automobile than the vehicle-interior-side bent section 12a is, as illustrated in (c) of FIG. 7.

The weather strip in accordance with the present invention further encompasses, as an embodiment, the weather strip 70 having a structure in which a protruding section (sub lip section) 76 having a projecting cross section is provided in place of the sub lip section 16, as illustrated in (d) of FIG. 7. The protruding section 76 is arranged similarly to the sub lip section 66 of the weather strip 60 in terms of positions of the protruding section 76 and a tip of the protruding section 76, and a direction in which the protruding section 76 protrudes.

The weather strip in accordance with the present invention also encompasses, as an embodiment, the weather strip 80 having a structure in which a sub lip section 86 is provided in place of the sub lip section 16, as illustrated in (e) of FIG. 7. The sub lip section 86 has a substantially L-shaped cross section and bends so as to protrude toward the inner side of the automobile. The sub lip section 86 is arranged similarly to the sub lip section 16 in terms of positions of the sub lip section 86 and a tip of the sub lip section 86, and a position of an outer surface of the sub lip section 86. Note that the cross section of the sub lip section 86 does not have be bent as described above. Instead, the sub lip section 86 may have a substantially C-shaped cross section (not shown) which is curved so as to protrude toward the inner side of the automobile. Further, the sub lip section 86 may be arranged such that a vehicle-interior-side side surface of a bent section of the sub lip section 86 is located closer to the inner side of the automobile than the vehicle-interior-side bent section 12a of the sealing section 12 is.

Furthermore, the weather strip in accordance with the present invention encompasses, as an embodiment, the weather strip 90 having a structure in which the sealing section 12 is arranged such that a first hole 12i is provided in the vehicle-interior-side upper wall section 12d and a second hole 12j is provided in the vehicle-exterior-side lower wall section 12g, as illustrated in (f) of FIG. 7. The first hole 12i serves as a drain hole for draining, into the hollow section 12h, water infiltrating from outside the vehicle through a gap (see (b) of FIG. 1) between the main lip section 15 and the sealing surface 4a of the back door 4. The second hole 12j serves as a drain hole for draining, to the outside of the automobile, water which has been drained into the hollow section 12h.

Note that the number of first holes 12i and second holes 12j, a location where each first hole 12i is provided in the vehicle-interior-side upper wall section 12d, and a location where each second hole 12j is provided in the vehicle-exterior-side lower wall section 12g are appropriately changeable.

### CONCLUSION

In order to attain the object, a weather strip in accordance with an aspect of the present invention is a weather strip attached to a peripheral section of an opening of an automobile, including: an attachment base secured along the peripheral section; a sealing section for sealing between the peripheral section and an opening and closing member for closing the opening, the sealing section being continuous with the attachment base and having (i) a vehicle-interior-side bent section which is bent so as to protrude toward an inner side of the automobile and (ii) a vehicle-exterior-side bent section which is bent so as to protrude toward an outer side of the automobile; a main lip section provided at a top of the sealing section and elastically coming into contact with the opening and closing member; and a sub lip section provided on a vehicle-interior-side upper wall section of the sealing section, the vehicle-interior-side upper wall section being provided between the top and the vehicle-interior-side bent section, the sub lip section elastically coming into contact with the opening and closing member, in a state where the weather strip seals between the peripheral section and the opening and closing member, a space surrounded by the main lip section, the sub lip section, the vehicle-interior-side upper wall section, and the opening and closing member being contained in a region between the sealing section and the opening and closing member facing each other.

According to the arrangement above, two lip sections, namely the main lip section and the sub lip section, of the weather strip in accordance with the present invention elastically comes into contact with the opening and closing member. This allows the weather strip in accordance with the present invention to exhibit better sound insulating properties and better sealing properties, as compared with a case in which only a single lip section is provided.

Further, according to the arrangement above, the sealing section has the vehicle-interior-side bent section and the vehicle-exterior-side bent section, and the sub lip section is provided on the vehicle-interior-side upper wall section of the sealing section. As such, compared to a case in which the sub lip section is provided at a tip of the sealing section, a position of the sub lip section does not significantly change between before and after the opening and closing member is closed. Accordingly, even in a case where closing of the opening and closing member causes the sealing section to bend, a state of contact between the opening and closing member and the sub lip section does not significantly change. This allows the weather strip in accordance with the present invention to exhibit stable sealing properties. Furthermore, since a position of the sub lip section changes toward the attachment base in accordance with bending of the vehicle-interior-side bent section, bending of the sealing section due to closing of the opening and closing member hardly causes any change in reactive force exerted to a portion where the opening and closing member and the sub lip section are in contact with each other. This allows the weather strip in accordance with the present invention to achieve a stable closing of the opening and closing member.

Furthermore, according to the arrangement above, in a state where the weather strip in accordance with the present invention seals between the peripheral section and the opening and closing member, a space surrounded by the main lip section, the sub lip section, the vehicle-interior-side upper wall section, and the opening and closing member is contained within a region between the sealing section and the opening and closing member facing each other. Since the sub lip section is thus compact, it is possible to suppress unintended deformation of the sub lip section at a corner of the peripheral section and improve contour following properties at the corner, accordingly. This allows the weather strip in accordance with the present invention to exhibit good sealing properties also at the corner of the peripheral section.

Furthermore, in order to attain the object, a weather strip in accordance with an aspect of the present invention is arranged such that: a tip of the sub lip section is located closer to the attachment base than a tip of the main lip section is; and a side surface of the sub lip section on the inner side of the automobile is located closer to the outer side of the automobile than the vehicle-interior-side bent section is.

According to the arrangement above, the weather strip in accordance with the present invention is arranged such that: the tip of the sub lip section is located closer to the attachment base than the tip of the main lip section is; and the side surface of the sub lip section on the inner side of the automobile is located closer to the outer side of the automobile than the vehicle-interior-side bent section is. This allows the sub lip section to be even more compact and, accordingly, allows the weather strip to achieve a further improvement in contour following properties at a corner of the peripheral section.

Furthermore, in order to attain the object, a weather strip in accordance with an aspect of the present invention is preferably arranged such that the sub lip section extends from the sealing section in a direction which is from the inner side to the outer side of the automobile.

According to the arrangement above, the sub lip section extends from the sealing section in a direction which is from the inner side to the outer side of the automobile. As such, compared to a case in which the sub lip section extends from the outer side to the inner side of the automobile, it is less likely, for example, to have unintended deformation such as warpage of a portion of the sub lip section which portion corresponds to a corner of the peripheral section. This allows the weather strip to achieve a further improvement in contour following properties at a corner of the peripheral section.

Furthermore, in order to attain the object, a weather strip in accordance with an aspect of the present invention is preferably arranged such that: the sealing section has a hollow section provided therein and a vehicle-exterior-side lower wall section provided between the attachment base and the vehicle-exterior-side bent section; the vehicle-interior-side upper wall section has provided therein a first hole for draining water into the hollow section; and the vehicle-exterior-side lower wall section has provided therein a second hole for draining water to an outside of the automobile.

According to the arrangement above, the vehicle-interior-side upper wall section has the first hole provided therein, and the vehicle-exterior-side lower wall section has the second hole provided therein. As such, in a case where water infiltrates from outside the automobile through a gap between the main lip section and the opening and closing member while the opening and closing member is in a closed state, the water is drained into the hollow section through the first hole and also drained from the hollow section to the outside of the automobile through the second hole. This allows the weather strip to achieve good sealing properties, good sound insulating properties, and the like, ensure a good closing of the opening and closing member, and also have good drainage properties.

Furthermore, in order to attain the object, a weather strip in accordance with an aspect of the present invention is preferably arranged such that the opening and the opening and closing member are provided in a rear section of the automobile.

According to the arrangement above, the weather strip is able to ensure a good closing of a trunk, a back door, and the like while allowing effective sealing between an opening and closing member, such as the trunk or the back door, and the peripheral section.

### REFERENCE SIGNS LIST

1: automobile
3: door opening (opening)
3a: peripheral section
4: back door (opening and closing member)
10, 20, 30, 40, 50, 60, 70, 80, and 90: weather strip
11: attachment base
12: sealing section
12a: vehicle-interior-side bent section
12b: vehicle-exterior-side bent section
12c: top (top of sealing section)
12d: vehicle-interior-side upper wall section
12g: vehicle-exterior-side lower wall section
12h: hollow section
12i: first hole
12j: second hole
15: main lip section
15a: tip (tip of main lip section)
16, 66, and 86: sub lip section
16a: tip (tip of sub lip section)
16b: outer surface (vehicle-interior-side side surface of sub lip section)
46: second sub lip section (sub lip section)
56: bulging section (sub lip section)
76: protruding section (sub lip section)
S: space
R: region

1. A weather strip attached to a peripheral section of an opening of an automobile, comprising:
an attachment base secured along the peripheral section;
a sealing section for sealing between the peripheral section and an opening and closing member for closing the opening, the sealing section being continuous with the attachment base and having (i) a vehicle-interior-side bent section which is bent so as to protrude toward an inner side of the automobile and (ii) a vehicle-exterior-side bent section which is bent so as to protrude toward an outer side of the automobile;
a main lip section provided at a top of the sealing section and elastically coming into contact with the opening and closing member; and
a sub lip section provided on a vehicle-interior-side upper wall section of the sealing section, the vehicle-interior-side upper wall section being provided between the top and the vehicle-interior-side bent section, the sub lip section elastically coming into contact with the opening and closing member,
in a state where the weather strip seals between the peripheral section and the opening and closing member, a space surrounded by the main lip section, the sub lip section, the vehicle-interior-side upper wall section, and the opening and closing member being contained in a region between the sealing section and the opening and closing member facing each other.

2. The weather strip as set forth in claim 1, wherein:
a tip of the sub lip section is located closer to the attachment base than a tip of the main lip section is; and
a side surface of the sub lip section on the inner side of the automobile is located closer to the outer side of the automobile than the vehicle-interior-side bent section is.

3. The weather strip as set forth in claim 1, wherein the sub lip section extends from the sealing section in a direction which is from the inner side to the outer side of the automobile.

4. The weather strip as set forth in claim 2, wherein the sub lip section extends from the sealing section in a direction which is from the inner side to the outer side of the automobile.

5. The weather strip as set forth in claim 1, wherein:
the sealing section has a hollow section provided therein and a vehicle-exterior-side lower wall section provided between the attachment base and the vehicle-exterior-side bent section;
the vehicle-interior-side upper wall section has provided therein a first hole for draining water into the hollow section; and
the vehicle-exterior-side lower wall section has provided therein a second hole for draining water to an outside of the automobile.

6. The weather strip as set forth in claim 2, wherein:
the sealing section has a hollow section provided therein and a vehicle-exterior-side lower wall section provided between the attachment base and the vehicle-exterior-side bent section;
the vehicle-interior-side upper wall section has provided therein a first hole for draining water into the hollow section; and
the vehicle-exterior-side lower wall section has provided therein a second hole for draining water to an outside of the automobile.

7. The weather strip as set forth in claim 1, wherein:
the sub lip section extends from the sealing section in a direction which is from the inner side to the outer side of the automobile;
the sealing section has a hollow section provided therein and a vehicle-exterior-side lower wall section provided between the attachment base and the vehicle-exterior-side bent section;
the vehicle-interior-side upper wall section has provided therein a first hole for draining water into the hollow section; and
the vehicle-exterior-side lower wall section has provided therein a second hole for draining water to an outside of the automobile.

8. The weather strip as set forth in claim 2, wherein:
the sub lip section extends from the sealing section in a direction which is from the inner side to the outer side of the automobile;
the sealing section has a hollow section provided therein and a vehicle-exterior-side lower wall section provided between the attachment base and the vehicle-exterior-side bent section;
the vehicle-interior-side upper wall section has provided therein a first hole for draining water into the hollow section; and
the vehicle-exterior-side lower wall section has provided therein a second hole for draining water to an outside of the automobile.

9. The weather strip as set forth in claim 1, wherein the opening and the opening and closing member are provided in a rear section of the automobile.

10. The weather strip as set forth in claim 9, wherein:
a tip of the sub lip section is located closer to the attachment base than a tip of the main lip section is;
a side surface of the sub lip section on the inner side of the automobile is located closer to the outer side of the automobile than the vehicle-interior-side bent section is;
the sub lip section extends from the sealing section in a direction which is from the inner side to the outer side of the automobile;
the sealing section has a hollow section provided therein and a vehicle-exterior-side lower wall section provided between the attachment base and the vehicle-exterior-side bent section;
the vehicle-interior-side upper wall section has provided therein a first hole for draining water into the hollow section; and
the vehicle-exterior-side lower wall section has provided therein a second hole for draining water to an outside of the automobile.
